(19) United States
(12) Patent Application Publication
(10) Pub. No.: US 2004/0251759 A1
(43) Pub. Date: Dec. 16, 2004

(54) Radial airgap, transverse flux motor

(76) Inventor: Andrew D. Hirzel, Kalamazoo, MI (US)

Correspondence Address: Ernest D. Buff, Ernest D. Buff & Associates, LLC, 231 Somerville Road, Bedminster, NJ, 07921, US

(21) Appl. No.: 10/864,041

(22) Filed: Jun. 9, 2004

Related U.S. Application Data
(60) Provisional application No. 60/478,074, filed on Jun. 12, 2003.

(51) Int. Cl. H02K 16/00; H02K 16/02

(52) U.S. Cl. 310/114; 310/156.25; 310/254

(57) ABSTRACT

A radial gap, transverse flux dynamoelectric machine comprises stator and rotor assemblies. The rotor assembly comprises at least two axially spaced, planar rotor layers having equal numbers of magnetic poles of alternating polarity disposed equiangularly about the rotor peripheral circumference. A magnetically permeable member optionally links adjacent rotor magnets. The stator assembly comprises a plurality of amorphous metal stator cores terminating in first and second polefaces. The cores are disposed equiangularly about the peripheral circumference of the stator assembly with their polefaces axially aligned. Respective first and second polefaces are in layers radially adjacent corresponding rotor layers. Stator windings encircle the stator cores. The device is operable at a high commutating frequency and may have a high pole count, providing high efficiency, torque, and power density, along with flexibility of design, ease of manufacture, and efficient use of magnetic materials.

### RELATED U.S. APPLICATION DATA

This application claims the benefit of co-pending U.S. Provisional Application Ser. No. 60/478,074, filed Jun. 12, 2003, and entitled “Radial Airgap Transverse Flux Motor Using Amorphous, Nanocrystalline Grain-Oriented Fe-Based Materials Or Non-Grain-Oriented Fe-Based Materials,” which is incorporated herein in the entirety by reference thereto.

### BACKGROUND OF THE INVENTION

1. Field of the Invention

The present invention relates generally to a dynamoelectric rotating machine, and more particularly, to an electric motor, generator, or regenerative motor that is highly efficient and has improved performance characteristics as a result of the use therein of advanced magnetic materials.

2. Description of the Prior Art

The electric motor and generator industry is continuously searching for ways to provide dynamoelectric, rotating machines with increased efficiencies and power densities. As used herein, the term “motor” refers to all classes of motoring and generating machines which convert electrical energy to rotational motion and vice versa. Such machines include devices which may alternatively be called motors, generators, and regenerative motors. The term regenerative motor is used herein to refer to a device that may be operated as either an electric motor or a generator. A wide variety of motors are known, including permanent magnet, wound field, induction, variable reluctance, switched reluctance, and brush and brushless types. They may be energized directly from a source of direct or alternating current provided by the electric utility grid, batteries, or other alternative source. Alternatively, they may be supplied by current having the requisite waveform that is synthesized using electronic drive circuitry. Rotational energy derived from any mechanical source may drive a generator. The generator's output may be connected directly to a load or conditioned using electronic circuitry. Optionally, a given machine connected to a mechanical source that functions as both a source or sink of mechanical energy during different periods in its operation can act as a regenerative motor, e.g. by connection through power conditioning circuitry capable of four-quadrant operation.

Rotating machines ordinarily include a stationary component known as a stator and a rotating component known as a rotor. Adjacent faces of the rotor and stator are separated by a small airgap traversed by magnetic flux linking the rotor and stator. It will be understood by those skilled in the art that rotating machines may comprise one or more joined rotors and one or more stators. Accordingly, the terms “a rotor” and “a stator” as used herein with reference to rotating machines mean a number of rotors and stators ranging from one to as many as three or more. Virtually all rotating machines are conventionally classifiable as being either radial or axial airgap types. A radial airgap type is one in which the rotor and stator are separated radially and the traversing magnetic flux is directed predominantly perpendicular to the axis of rotation of the rotor. In an axial airgap device, the rotor and stator are axially separated and the flux traversal is predominantly parallel to the rotational axis. Although axial airgap devices are advantageous in certain applications, radial airgap types are more commonly used and have been studied more extensively.

Except for certain specialized types, motors and generators generally employ soft magnetic materials of one or more types. By “soft magnetic material” is meant one that is easily and efficiently magnetized and demagnetized. The energy that is inevitably dissipated in a magnetic material during each magnetization cycle is termed hysteresis loss or core loss. The magnitude of hysteresis loss is a function both of the excitatation amplitude and frequency. A soft magnetic material further exhibits high permeability and low magnetic coercivity. Motors and generators also include a source of magnetomotive force, which can be provided either by one or more permanent magnets or by additional soft magnetic material encircled by current-carrying windings. By “permanent magnet material,” also called “hard magnetic material,” is meant a magnetic material that has a high magnetic coercivity and strongly retains its magnetization and resists being demagnetized. Depending on the type of motor, the permanent and soft magnetic materials may be disposed either on the rotor or stator.

By far, the preponderance of motors currently produced use as soft magnetic material various grades of electrical or motor steels, which are alloys of Fe with one or more alloying elements, especially including Si, P, C, and Al. While it is generally believed that motors and generators having rotors constructed with advanced permanent magnet material and stators having cores made with advanced, low-loss soft materials, such as amorphous metal, have the potential to provide substantially higher efficiencies and power densities compared to conventional radial airgap motors and generators, there has been little success in building such machines of either axial or radial airgap type. Previous attempts at incorporating amorphous material into conventional radial airgap machines have been largely unsuccessful commercially. Early designs mainly involved substituting the stator and/or rotor with coils or circular laminations of amorphous metal, typically cut with teeth through the internal or external surface. Amorphous metal has unique magnetic and mechanical properties that make it difficult or impossible to directly substitute for ordinary steels in conventionally designed motors.

For example, U.S. Pat. No. 4,286,188 discloses a radial airgap electric motor having a centrally located rotor constructed by simply coiling a strip of amorphous metal tape. The stator of the design is a conventional stator comprising a stack of conventional laminations provided with stator winding slots, which receive a suitable stator winding.

U.S. Pat. No. 4,392,073 discloses a stator for use in a radial airgap dynamoelectric machine having a centrally located rotor, and related U.S. Pat. No. 4,403,401 discloses a method for making that stator. The stator is constructed by slotting a strip of amorphous metal tape and helically winding the slotted amorphous metal tape into a slotted toroid, which is then wound with suitable stator winding.

U.S. Pat. No. 4,211,944 discloses a radial airgap electric machine with a laminated stator or rotor core made from slotted or slotless helically wound or edge-wound amorphous metal ribbons. A dielectric material is placed between the amorphous metal ribbons so that they also function as plates of an integral capacitor.

U.S. Pat. No. 4,255,684 discloses a stator structure for use in a motor which is fabricated using strip material- and moldable magnetic composite, either amorphous metal tape and amorphous flake or similar conventional materials. These and other prior art designs have proved too costly and difficult for making a radial airgap motor using amorphous metal. For a variety of reasons, these efforts have not provided designs that are competitive, and have apparently been abandoned because the designs did not prove competitive against conventional Si—Fe motors. However, the potential benefit and value of an improved radial airgap motor has not diminished.

For some time now, high speed (i.e., high rpm) electric machines have been manufactured with low pole counts, since electric machines operating at higher frequencies result in significant core losses that contribute to inefficient motor design. This is mainly due to the fact that the material used in the vast majority of present motors is a silicon-iron alloy (Si—Fe). It is well known that losses resulting from changing a magnetic field at frequencies greater than about 400 Hz in conventional Si—Fe-based materials causes the material to heat, oftentimes to a point where the device cannot be cooled by any acceptable means. A number of applications in current technology, including widely diverse areas such as high-speed machine tools, aerospace motors and actuators, and compressor drives, require electrical motors operable at high speeds, many times in excess of 15,000-20,000 rpm, and in some cases up to 100,000 rpm.

To date it has proven very difficult to cost effectively provide a readily manufacturable electric device, which takes advantage of low-loss materials. There remains a need in the art for highly efficient radial airgap electric devices, which take full advantage of the specific characteristics associated with low-loss material, thus eliminating the disadvantages associated with the conventional motors. Ideally, an improved motor would provide higher efficiency of conversion between mechanical and electrical energy forms, which often would result in concomitantly reduced air pollution. The motor would be smaller, lighter, and satisfy more demanding requirements of torque, power, and speed. Cooling requirements would be reduced, and motors operating from battery power would operate longer.

### SUMMARY OF THE INVENTION

There is provided a radial airgap electric machine having a rotor and a stator assembly, the stator assembly including magnetic cores made from low-loss material capable of high frequency operation. Preferably, the stator's soft magnetic cores are made of amorphous, nanocrystalline, grain-oriented Fe-based material or non-grain-oriented Fe-based material and have a horseshoe-shaped design wound with stator windings on each end. The stator cores are coupled to one or more rotors. The inclusion of amorphous, nanocrystalline or flux-enhancing Fe-based magnetic material in the present electrical device enables the machine's frequency to be increased without a corresponding increase in core loss, thus yielding a highly efficient electric apparatus capable of providing increased power density. The apparatus has a radial airgap, transverse flux design. That is to say, magnetic flux traverses an airgap between rotor and stator predominantly in a radial direction, i.e. a direction perpendicular to the rotational axis of the machine. In addition, the apparatus is a transverse flux machine, by which is meant that flux closes through the stator in a direction that is predominantly transverse, i.e. along a direction parallel to the rotational axis.

In one embodiment, a dynamoelectric machine in accordance with the invention comprises at least one stator assembly, a plurality of stator windings, and at least one rotor assembly supported for rotation about a rotational axis, the rotor and stator assemblies being concentric with the rotational axis. The rotor assembly comprises at least one rotor magnet structure providing magnetic poles having north and south polarity. The poles are disposed in at least two rotor layers that are substantially planar, perpendicular to the rotational axis, and axially spaced apart. Each of the layers has the same number of poles. The poles in each layer are disposed equiangularly about the circumference of the rotor assembly on a cylindrical periphery thereof.

The stator assembly comprises a plurality of stator cores, each of the stator cores terminating in a first and a second stator poleface. The stator cores are disposed equiangularly about the circumference of the stator assembly, such that: (i) the first and second stator polefaces of each of the stator cores are situated on a cylindrical periphery of the stator assembly in axial alignment; (ii) the first stator polefaces are in a first stator layer radially adjacent one of the rotor layers; and (iii) the second stator polefaces are in a second stator layer adjacent another of the rotor layers. The stator windings encircle the stator cores.

In some embodiments, the rotor magnet structure comprises one or more pieces of permanent magnetic material having one or more pole pairs. The rotor magnetic structure in other embodiments comprises a plurality of discrete rotor magnets. In such embodiments, one of the poles of each of the discrete magnets is optionally magnetically linked to a pole of an adjacent one of the magnets by a magnetically permeable linking member.

Various embodiments in accordance with the present invention provide highly efficient electric devices having improved performance characteristics, such as a high pole count capable of operating simultaneously at high frequencies and low magnetic core loss and high power density.

Some embodiments of the present machine have a radial airgap, transverse flux configuration in which the number of slots in a magnetic core divided by the number of phases in the stator winding divided by the number of poles in the arrangement optimally has a value of 0.5.

### BRIEF DESCRIPTION OF THE DRAWINGS

The invention will be more fully understood and further advantages will become apparent when reference is had to the following detailed description of the preferred embodiments of the invention and the accompanying drawings, wherein like reference numeral denote similar elements throughout the several views and in which:

FIG. 1 is a partial axial cross-sectional view of a radial airgap motor in accordance with an embodiment of the invention, showing a portion of a rotor assembly centrally located about the rotational axis of the motor “X” and a portion of a concentric, spaced apart stator assembly;

FIG. 2 is a transverse cross-sectional view along the line A-A of FIG. 1, showing the orientation of the stator core and discrete rotor magnets along the axis of the motor;

FIG. 3 is a partial axial cross-sectional view of a radial airgap motor in accordance with an embodiment of the invention, showing a portion of a rotor assembly extending to the rotational axis of the motor “X” and a portion of a concentric, spaced apart stator assembly;

FIG. 4 is a transverse cross-sectional view along the axis of FIG. 3, showing the stator core and rotor magnets mounted in the stator carrier and rotor carrier, respectively, and the shaft bearings for rotation of the rotor;

FIG. 5 is a partial cross-sectional view depicting the lamination direction of the stator cores and linking members along a view similar to that of FIGS. 1 and 3;

FIG. 6 is a transverse cross sectional view depicting the lamination direction of the stator cores and linking members along a view similar to that of FIGS. 2 and 4;

FIG. 7 is a partial axial cross-sectional view of a radial gap motor in accordance with an embodiment of the invention with a distributed winding scheme, wherein multiple stator cores share a common stator coil;

FIG. 8 is a transverse cross-sectional view taken along the line A-A of FIG. 7, showing the orientation of the stator core and rotor magnets along the axis of the motor;

FIG. 9: is a partial cross-sectional view of a radial gap motor in accordance with another embodiment of the invention having a distributed winding scheme (multiple stator cores sharing a common stator coil) and wherein the linking members link pairs of rotor magnets within the plane of a rotor assembly;

FIG. 10 is a transverse cross-sectional view taken along the line A-A of FIG. 9, showing the lamination direction of the stator core and the linking members along the axis of the motor;

FIG. 11 is a partial cross-sectional view a radial gap motor in accordance with an embodiment of the invention having a rotor assembly radially outward of a stator assembly;

FIG. 12 is a transverse cross-sectional view taken along the line A-A of FIG. 11, showing the orientation of the stator core and rotor magnets along the axis of the motor;

FIG. 13 is a partial axial cross-sectional view of a radial airgap motor in accordance with another embodiment of the invention, comprising multiple rotor assemblies and stator assemblies;

FIG. 14 is a transverse cross-sectional view taken along the line A-A of FIG. 13, showing the orientation of the stator cores and rotor magnets along the axis of the motor;

FIG. 15 is a plan view of a wound coil of advanced magnetic material appointed to be cut to form two horseshoe-shaped cores for use in the stator of the present device;

FIG. 16 is a plan view of a wound coil of advanced magnetic material appointed to be cut to form two cores having an enlarged back portion for use in the stator of the present device; and

FIG. 17 is a plan view, partially cut away, of a section of a rotor assembly showing magnets in two layers that are circumferentially displaced.

### DESCRIPTION OF THE PREFERRED EMBODIMENTS

Preferred embodiments of the present invention will be explained in greater detail hereinafter, with reference to the accompanying figures. The present invention provides a radial airgap, transverse flux electric device, having stator cores made from low-loss material. Preferably the stator cores are made using material in the form of thin strip or ribbon consisting essentially of amorphous or nanocrystalline metal, or grain-oriented or non-grain-oriented Fe-based metal alloy materials. Grain-oriented Fe-based materials and non-grain-oriented Fe-based materials, which frequently have higher saturation induction than amorphous or nanocrystalline materials are collectively referred to herein as “flux enhancing Fe-based magnetic materials.”

Amorphous Metals

Amorphous metals, which are also known as metallic glasses, exist in many different compositions suitable for use in the present motor. Metallic glasses are typically formed from an alloy melt of the requisite composition that is quenched rapidly from the melt, e.g. by cooling at a rate of at least about 10⁶° C./s. They exhibit no long-range atomic order and have X-ray diffraction patterns that show only diffuse halos, similar to those observed for inorganic oxide glasses. A number of compositions having suitable magnetic properties are set forth in U.S. Pat. No. RE32,925 to Chen et al. Amorphous metal is typically supplied in the form of extended lengths of thin ribbon (e.g. a thickness of at most about 50 μm) in widths of 20 cm or more. A process useful for the formation of metallic glass strips of indefinite length is disclosed by U.S. Pat. No. 4,142,571 to Narasimhan. An exemplary amorphous metal material suitable for use in the present invention is METGLAS® 2605 SA1, sold by Metglas, Inc., Conway, S.C. in the form of ribbon of indefinite length and up to about 20 cm wide and 20-25 μm thick (see http://www.metglas.com/products/page5_{—}1_{—}2_{—}4.htm). Other amorphous materials with the requisite properties may also be used.

Amorphous metals have a number of characteristics that must be taken into account in the manufacture and use of magnetic implements. Unlike most soft magnetic materials, metallic glasses are hard and brittle, especially after the heat treatment typically used to optimize their soft magnetic properties. As a result, many of the mechanical operations ordinarily used to process conventional soft magnetic materials for motors are difficult or impossible to carry out on amorphous metals. Stamping, punching, or cutting as-produced material generally results in unacceptable tool wear and is virtually impossible on brittle, heat-treated material. Conventional drilling and welding, which are often done with conventional steels, are also normally precluded.

In addition, amorphous metals exhibit a lower saturation flux density (or induction) than Si—Fe alloys. The lower flux density ordinarily results in lower power densities in motors designed according to conventional methods. Amorphous metals also have lower thermal conductivities than Si—Fe alloys. As thermal conductivity determines how readily heat can be conducted through a material from a warm location to a cool location, a lower value of thermal conductivity necessitates careful design of the motor to assure adequate removal of waste heat arising from core losses in the magnetic materials, ohmic losses in the windings, friction, windage, and other loss sources. Inadequate removal of waste heat, in turn, would cause the temperature of the motor to rise unacceptably. Excessive temperature is likely to cause premature failure of electrical insulation or other motor components. In some cases, the over-temperature could cause a shock hazard or trigger catastrophic fire or other serious danger to health and safety. Amorphous metals also exhibit a higher coefficient of magnetostriction than certain conventional materials. A material with a lower coefficient of magnetostriction undergoes smaller dimensional change under the influence of a magnet field, which in turn would likely reduce audible noise from a machine, as well as render the material more susceptible to degradation of its magnetic properties as the result of stresses induced during machine fabrication or operation.

Despite these challenges, an aspect of the present invention provides a motor that successfully incorporates amorphous metals and permits motor operation with high frequency excitation, e.g., a commutating frequency greater than about 400 Hz. Construction techniques for the fabrication of the motor are also provided. As a result of the configuration and the use of advanced materials, especially amorphous metals, the present invention successfully provides a motor that operates at high frequencies (defined as commutating frequencies greater than about 400 Hz) with a high pole count. The amorphous metals exhibit much lower hysteresis losses at high frequencies, which result in much lower core losses. Compared to Si—Fe alloys, amorphous metals have much lower electrical conductivity and are typically much thinner than ordinarily used Si—Fe alloys, which are often 200 μm thick or more. Both these characteristics promote lower eddy current core losses. The invention successfully provides a motor that benefits from one or more of these favorable attributes and thereby operates efficiently at high frequencies, using a configuration that permits the advantageous qualities of the amorphous metal, such as the lower core loss, to be exploited, while avoiding the challenges faced in previous attempts to use advanced materials.

Nanocrystalline Metals

Nanocrystalline materials are polycrystalline materials with average grain sizes of about 100 nanometers or less. The attributes of nanocrystalline metals as compared to conventional coarse-grained metals generally include increased strength and hardness, enhanced diffusivity, improved ductility and toughness, reduced density, reduced modulus, higher electrical resistance, increased specific heat, higher thermal expansion coefficients, lower thermal conductivity, and superior soft magnetic properties. Nanocrystalline metals also have somewhat higher saturation induction in general than most Fe-based amorphous metals.

Nanocrystalline metals may be formed by a number of techniques. One preferred method comprises initially casting the requisite composition as a metallic glass ribbon of indefinite length, using techniques such as those taught hereinabove, and forming the ribbon into a desired configuration such as a wound shape. Thereafter, the initially amorphous material is heat-treated to form a nanocrystalline microstructure therein. This microstructure is characterized by the presence of a high density of grains having average size less than about 100 nm, preferably less than about 50 nm, and more preferably about 10-20 nm. The grains preferably occupy at least 50% of the volume of the iron-base alloy. These preferred materials have low core loss and low magnetostriction. The latter property also renders the material less vulnerable to degradation of magnetic properties by stresses resulting from the fabrication and/or operation of a device comprising the component. The heat treatment needed to produce the nanocrystalline structure in a given alloy must be carried out at a higher temperature or for a longer time than would be needed for a heat treatment designed to preserve therein a substantially fully glassy microstructure. Representative nanocrystalline alloys suitable for use in constructing magnetic elements for the present device are known, e.g. alloys set forth in U.S. Pat. No. 4,881,989 to Yoshizawa and U.S. Patent No. to Suzuki et al. Such materials are available from Hitachi Metals and Alps Electric.

Grain-Oriented and Non-Grain-Oriented Metals

The present machines may also be constructed with low-loss Fe-based crystalline alloy material. Preferably such material has the form of strip having a thickness of less than about 125 μm, much thinner than the steels conventionally used in motors, which have thicknesses of 200 μm or more, and sometimes as much as 400 μm or more. Both grain-oriented and non-oriented materials may be used. As used herein, an oriented material is one in which the principal crystallographic axes of the constituent crystallite grains are not randomly oriented, but are predominantly correlated along one or more preferred directions. As a result of the foregoing microstructure, an oriented strip material responds differently to magnetic excitation along different directions, whereas a non-oriented material responds isotropically, i.e., with substantially the same response to excitation along any direction in the plane of the strip. Grain-oriented material is preferably disposed in the present motor with its easy direction of magnetization substantially coincident with the predominant direction of magnetic flux.

The non-grain-oriented Fe-based material used in constructing machines in accordance with the invention preferably consists essentially of an alloy of Fe with Si in an amount ranging from about 4 to 7 wt. % Si. Preferred non-oriented alloys have a composition consisting essentially of Fe with about 6.5 wt. % Si and exhibit near-zero values of saturation magnetostriction, making them less susceptible to deleterious magnetic property degradation due to stresses encountered during construction or operation of a device containing the material. One form of Fe-6.5Si alloy is supplied as magnetic strips 50 and 100 μm thick by the JFE Steel Corporation, Tokyo, Japan (see also http://www.jfe-steel.co.jp/en/products/electrical/supercore/index.html). Fe-6.5% Si produced by rapid solidification processing, as disclosed by U.S. Pat. No. 4,865,657 to Das et al. and U.S. Pat. No. 4,265,682 to Tsuya et al. also may be used.

General Structure of Motor

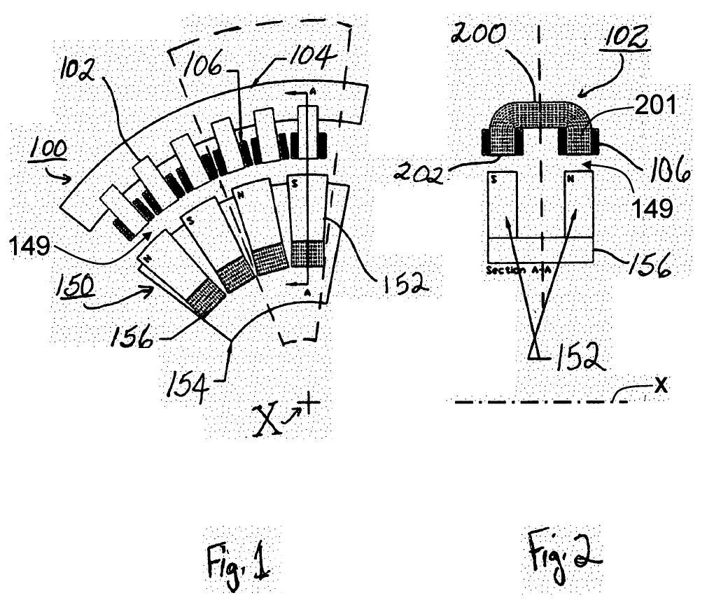

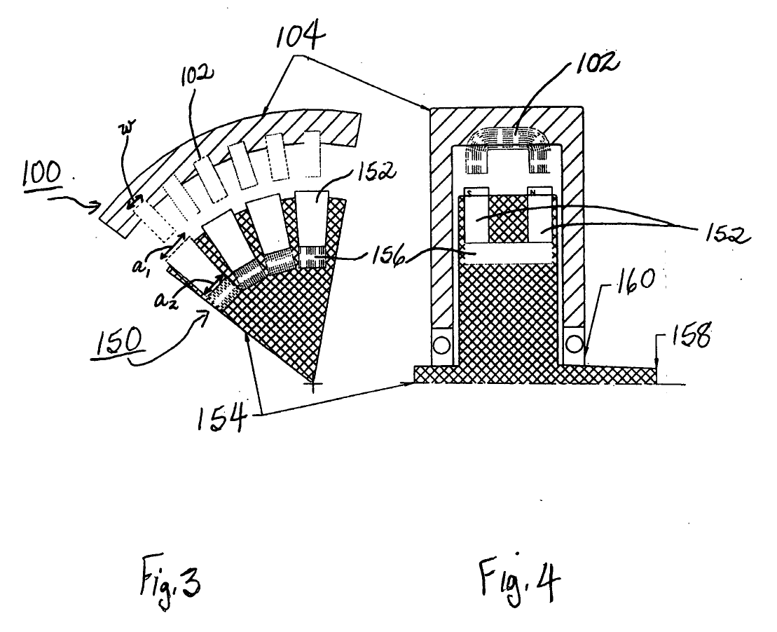

FIGS. 1 and 2 illustrate the general structure of a radial airgap, transverse flux motor in an implementation of the present invention. Referring to FIG. 1 there is seen a centrally located rotor assembly 150, and a concentric stator assembly 100. The stator assembly 100 comprises a plurality of stator cores 102 mounted on (or set into) a carrier 104, and wound with stator coils or windings 106. Carrier 104 may be the stator housing or a separate part inside a motor housing (not shown). The rotor assembly 150 may be supported by bearings of any suitable type (not shown) that dispose it for rotation about rotational axis X. Rotor assembly 150 comprises a rotor magnet structure having discrete rotor magnets 152 mounted on (or set into) a rotor carrier 154. FIG. 2 provides a sectional view along the line A-A of FIG. 1, showing in greater detail the orientation of a stator core 102 relative to the rotor magnets 152. For clarity, neither stator carrier 104 nor rotor carrier 154 is shown in FIG. 2.

Magnets are disposed in axially separated, substantially planar rotor layers that are substantially perpendicular to the rotational axis. Equal numbers of magnets 152 are in each layer and are equiangularly disposed about the circumference of rotor assembly 150. Each magnet 152 has a polarity defining north (N) and south (S) poles at opposite ends thereof, with one end of each magnet being situated on a cylindrical periphery of rotor assembly 150. The peripheral ends of the magnets in each layer have circumferentially alternating north and south poles. In the embodiment of FIGS. 1-2, the magnets in the two layers are situated in axial alignment, such that the axially corresponding and adjacent peripheral ends have opposite polarity. It will be understood that the rotor assembly 150 may alternatively comprise plural subassemblies, each containing some of the rotor magnets. For example, rotor carrier 154 may be constructed in two sections, each providing a layer of magnets. In addition, each section might form only a portion of a whole layer.

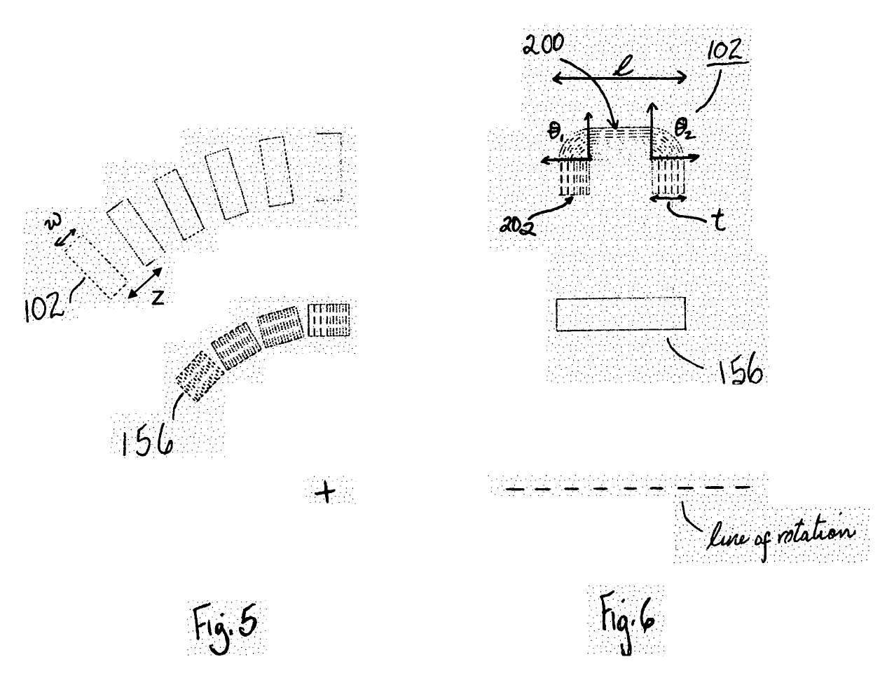

As shown in FIG. 1, a plurality of permanent magnets possessing alternating polarity are positioned about the circumference of rotor assembly 150. In different embodiments, the positioning and polarity of the magnets can vary, as desired for a particular electric device design. FIG. 2 further depicts magnetically permeable linking members 156, which are optionally included in the rotor magnet structure depicted in FIGS. 1 and 2. Each linking member 156 links one of the magnets to an adjacent one of the magnets, and is situated proximate an end of the linked magnets, the linked ends having alternating polarity. FIG. 4 provides a side view similar to that of FIG. 2 showing stator core 102 set into stator carrier 104, and rotor magnets 152 and linking member 156 set into rotor carrier 154. While the embodiments of FIGS. 1-4 show linking members 156, in other embodiments linking members 156 are absent.

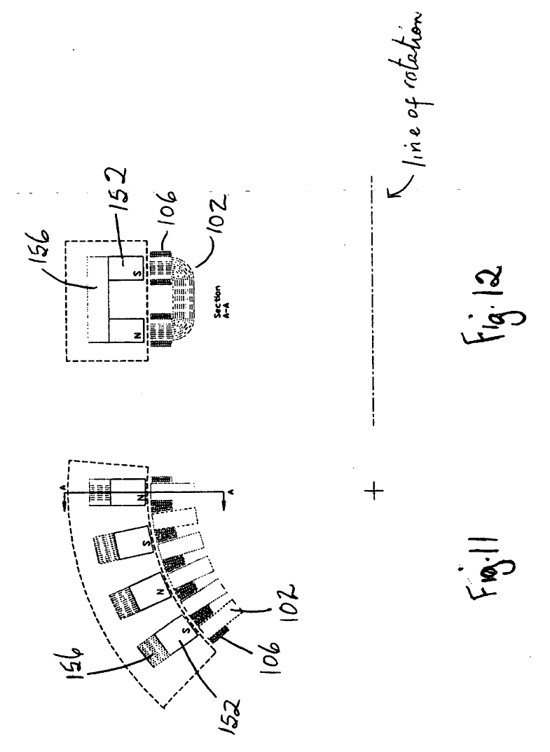

Linking member 156 is illustrated in FIGS. 1 and 2 as a rectangular block of laminated, flat strips, comprised of a magnetically permeable material, which preferably is selected from the group consisting of amorphous, nanocrystalline, and flux-enhancing Fe-based magnetic material. Linking member 156 connects the rotor magnets 152 from two different layers of rotor assembly 150. This member 156 serves to conduct magnetic flux from one rotor magnet 152 to an axially adjacent rotor magnet 152, thereby providing a higher permeability flux path for the magnets. As a result, magnet flux is increased, so that motor volume may be reduced without decreasing motor performance, by using magnets having a smaller volume. Permanent magnets, especially rare earth-based magnets such as SmCo and FeNdB are among the most expensive components of the motor, providing considerable incentive to minimize the amount of permanent magnet material required. FIG. 4 illustrates one possible positioning of the linking member 156 set into rotor carrier 154 and linking axially adjacent magnets. In addition to the laminated form -shown in FIGS. 1-2, linking member 156 alternately can comprise any magnetically permeable material, including solid steel. In one preferred embodiment, the linking member comprises rectangular blocks positioned substantially parallel to the shaft 158, where the face of a sheet of the laminations of linking member 156 is shown in the view of FIG. 4. An alternative orientation of the linking member 156 is illustrated in FIGS. 9 and 10, where each linking member 156 links to two rotor magnets 152 within the plane of the view of FIG. 9. Each sheet of the lamination also lies within the plane of FIG. 9. In the view of FIG. 10, the sheets of lamination are shown to run perpendicular to the line of rotation. While the linking members 156 are illustrated as rectangular blocks, they can be of any shape. For example, other prismatic shapes can be used, as can horseshoe cores similar to those used in the FIG. 1 stator assembly. Additionally, linking member 156 can connect one or more pairs of rotor magnets 152. FIG. 2 and FIG. 9 illustrate a configuration in which linking members are connected to only a single pair of magnets. In various embodiments, linking member 156 can span a greater number or all of the magnets in a single rotor assembly 150 simultaneously, or even span all of the magnets in any number of rotor assemblies 150. However, linking members 156 are optional components, and in different embodiments one or more linking members 156 may be absent.

Preferably, linking member 156, if used, has low hysteresis losses to improve machine efficiency. As the rotor turns during machine operation, changes in the reluctance of portions of the magnetic circuit result in time-varying flux in the permanent magnets, and hence in the linking members. Such variation results in hysteresis loss in the linking member, decreasing efficiency and necessitating dissipation of the waste heat generated. Hence, use of a low-loss linking member is preferred.

Each stator core 102 has a horseshoe shape that includes a base portion 200 and two legs 201 depending in generally parallel directions therefrom and terminating in stator core ends 202. Base portion 200 of stator core 102 is mounted in carrier 104, while stator coils 106 are wound around stator core legs 201. Stator coils 106 are electrically wired to produce a magnetic field in the stator core 102 that will repel or attract the centrally located rotor magnets 152. Lines of magnetic flux emerge from ends 202, which form polefaces for the stator core 102. As best seen in FIG. 2, the two polefaces 202 of a stator core are substantially coplanar and axially aligned. The stator cores are disposed equiangularly about the circumference of the stator assembly with their respective faces situated on a cylindrical periphery of the stator assembly.

Stator core 102 comprises sheets or ribbons preferably composed of a material selected from the group consisting of amorphous, nanocrystalline, and flux enhancing Fe-based metal. More preferably, the material is composed of a non-oriented alloy consisting essentially of Fe with Si in an amount ranging from about 4 to 7 wt. % Si. Most preferred alloys include amorphous and nanocrystalline alloys and non-oriented Fe-6.5 wt. % Si. Preferably, the sheets within stator core 102 are bonded together, e.g. by impregnation with a low-viscosity epoxy resin.

In the embodiment of FIGS. 1 and 2, the cylindrical periphery of rotor assembly 150 is radially inward of the cylindrical periphery of stator assembly 100. These respective peripheries are in facing relationship across a radial airgap.

Stator cores are set into one or more appropriate housings, which can be made of metal, plastic, or other material having suitable mechanical and electrical properties. The stator cores are held in place within this housing(s) by a structural adhesive, such as single or two-part epoxy. FIGS. 3 and 4 illustrate another implementation, wherein rotor carrier 154 extends to the central axis of the motor. FIG. 4 provides a sectional view similar to that of FIG. 3, showing the rotor magnets 150 set into rotor carrier 154. Rotor assembly 150 in this implementation further comprises a shaft 158, to which rotor carrier 154, comprising magnets 152, is secured. Stator carrier 102 is stationary relative to the motor, while rotor assembly 150 rotates on bearings 160.

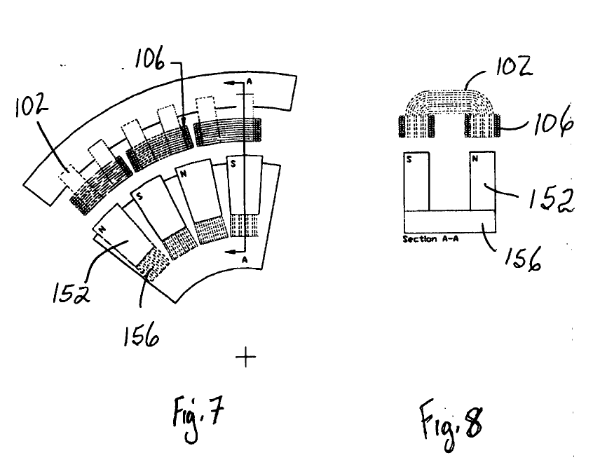

FIGS. 5 and 6 illustrate a top and a side view, respectively, showing further details concerning the construction of stator cores 102 (for clarity, stator carrier 104 is not shown). As best seen in FIG. 6, stator core 102 has a horseshoe shape with dimensions of length 1, width w, thickness t, and bending angles θ₁ and θ₂. In a specific embodiment, stator core 102 has a horseshoe shape with dimensions l=35 mm, w=20 mm, t=11 mm, and θ₁ and θ₂=90°. The dimensions of stator core 102 will vary with the stator design, and are chosen to optimize the performance of the electric device. A horseshoe shape is chosen to illustrate a stator core design used in some implementations, as it is readily manufactured using existing techniques. Variations or shape of stator core 102 or orientation of the sheets or ribbons comprising stator core 102 readily apparent to one of ordinary skill in the art are also considered within the scope of the present invention. For example, while stator core 102 is shown with uniform bend radii forming θ₁=θ₂=90°, angles θ₁ and θ₂ may be larger or smaller than 90°, or stator core 102 may be continuous as one long bend, i.e., forming a generally circular arc. The number of stator cores 102 and the circumferential distance of separation Z (see FIG. 5) within stator carrier 104 vary according to the design of the electric device.

Another form of stator core 102 is depicted by FIG. 16, in which base portion 202 is enlarged relative to the substantially parallel legs 201. Such a core configuration permits stator windings to be disposed in the enlarged portion, removing them radially from ends 202, and thereby reducing stray field eddy current losses induced in the windings by changing flux from the rotor magnets.

In a preferred embodiment, stator cores 102 are sized according to motor design principles based on Faraday's law applied to sinusoidal machine operation, which applies to all dynamoelectric machines. Based on these and related principles and required machine properties, the total stator volume, i.e., the gross volume, is preferably kept at a minimum. The design would preferably minimize all of the volume of the motor that is consumed by stator components, including stator cores 102 and the volumes taken up by the windings. A minimum of stator volume (Vₘᵢₙ) is preferred, where Vₘᵢₙ=t×w×(mean length from end face 202 to opposite end face 202). Reduction of the stator volume beneficially contributes to reduced core losses, which result in waste heat, and also reduced materials cost and total motor volume. The cross section (t×w) is optimized along with the magnetic flux density, in order to make an optimal number of lines of magnetic flux passing through coils 106. Increasing the area (t×w) decreases the area available for coils 106. The total machine power (Pₜₒₜ) is approximately proportional to the number of turns (n) of coil 106, multiplied by the area (t×w), multiplied by the magnetic flux density (B) in the region of coils 106, the frequency f, and the number of stator segments (N), i.e., Pₜₒₜ˜n×t×w×B×f×N.

Preferably, the orientation of the laminations of sheet- or ribbon-form amorphous, nanocrystalline, or flux-enhancing Fe-based metal comprising stator core 102 is chosen in consideration of the direction of the sinusoidally varying magnetic flux produced by the rotating rotor magnets. In the case of a radial airgap machine, the sinusoidal variation of the magnetic flux lies predominantly within a series of planes lying perpendicular to the axis of rotation of the rotor (i.e., within the plane of FIGS. 1 and 3). However, in an axial airgap machine, the sinusoidal variation of the magnetic flux lies within a series of cylinders lying co-axial with the axis of rotation. Preferably, the laminations of the stator core are substantially parallel to the planes or cylinders comprising the sinusoidally varying magnetic flux for the radial or axial airgap machine, respectively. FIGS. 4 and 6 show the lamination direction of the sheets or ribbons of material comprising stator core 102 for the radial airgap machine. The plane of the sheets of laminations near stator ends 202 is illustrated as substantially perpendicular to the axis of rotation of the rotor magnets (along shaft 158). Any flux from the rotor magnets that has a vector component perpendicular to the lamination plane in the stator core will induce eddy currents to flow in that plane, contributing unwanted eddy current losses. Accordingly, it is preferred that the stator core be disposed in such a way that substantially all the flux from the rotor magnets is present in a direction within the lamination plane, and not out of the plane.

Stator coils 106 preferably comprise highly conductive wire, such as copper or aluminum wire, which is wound encircling stator core legs 201 (see FIG. 2). However, the wire material is not restricted to copper, and may be any conductive material. The wires may have any desirable cross-section, such as round, square, or rectangular. Stranded wire may be used for ease of winding and for improved high-frequency performance. Any number of stator coils 106 may be used for each stator core 102. Stator coil 106 may be wound though the process of bobbin winding, wherein the coil is wound much like a sewing machine bobbin. The coil, which optionally is wound onto a coil former, is subsequently assembled onto stator core legs 201, which form the stator “teeth”. In the embodiment of FIGS. 1 and 2, the bobbin wound coil is assembled onto stator core legs 201. Additionally, in other embodiments, stator coils 106 may be also placed on base portion 200 of stator core 102, or on both base portion 200 and legs 201. As an alternative to bobbin winding, stator coil 106 may be wound through the process of needle winding, wherein the wires are wound onto an existing assembly of stator teeth, i.e., directly through stator core ends 202. Needle winding is commonly employed in the construction of conventional radial airgap machines, and can be done on any assembly of teeth.

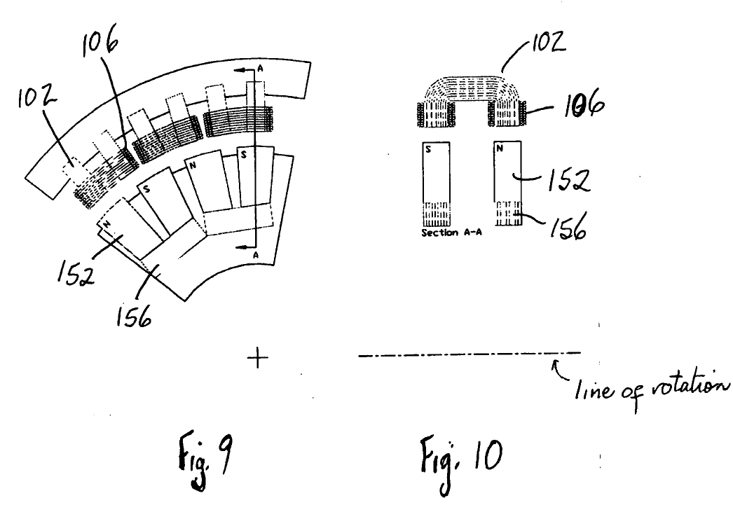

In other implementations, stator coil 106 windings are distributed, in that one or more electrical coils span multiple teeth or stator core ends 202, and overlap with other coils. FIGS. 7 and 8 illustrate an embodiment employing distributed coils, in which two stator cores 102 are wound with stator coils 106. In other distributed winding schemes, stator coils 106 encircle more than two stator cores.

The size and spacing of rotor magnets 152 in rotor carrier 154 is preferably chosen to minimize material waste while optimizing machine performance. In some embodiments, rotor magnets 152 are spaced such that there is little or no circumferential clearance between alternating magnets. In still other embodiments, discrete rotor magnets, such as magnets 152 shown in FIGS. 1-2 are not used. Instead, one or more pieces of permanent magnetic material, preferably arcuately shaped, are disposed around the circumference of rotor assembly 150. Each piece may provide a single N-S pole pair, with magnetic flux lines traveling in a semicircle path about the single-piece solid magnet from one face to the other. Alternatively, each piece may provide a plurality of pole pairs, for example poles printed on a bonded magnet. Linking members 156 ordinarily are not used with these magnet configurations.

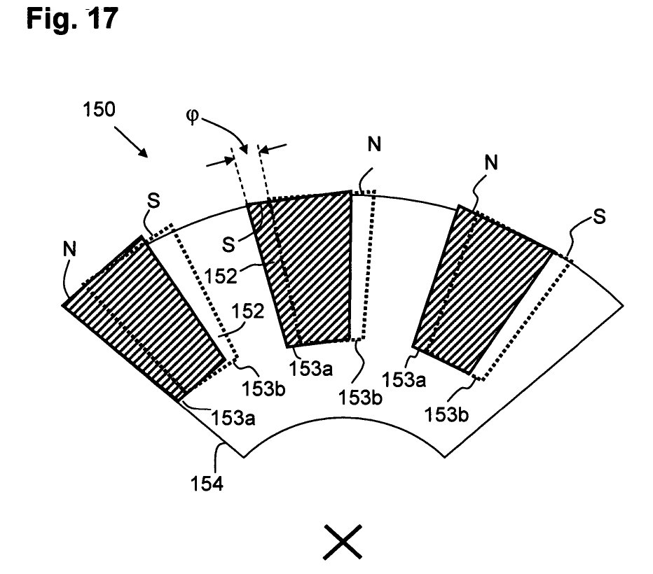

The magnets 152 in the one or more rotor assemblies 150 optionally may be staggered circumferentially, as shown in FIG. 17. That is to say, the magnet ends 153a in one layer may be rotated by a skew angle Φ from the corresponding ends 153b in the adjacent layer, as depicted in FIG. 17. A non-zero value of Φ is often selected to reduce torque cogging. As is known in the art, cogging is the variation in torque with rotational position in a machine after the input current is greatly reduced and while the shaft is at zero or very low rpm. Torque cogging may cause undesirable performance and acoustic problems. At any given rotor position, there are a number of north oriented flux lines traversing the radial airgap, as well as an equal number of south oriented flux lines crossing the gap, according to Gauss' law. A zero cogging machine is one in which the magnitude of the net value of the magnetic flux across the airgap is a constant, where flux lines from magnetic south lines are taken to be negative, and those from magnetic north as positive. In such a machine, there is no change in absolute value of magnetic flux crossing the radial airgap as the rotor is rotated. In practice, torque cogging is minimized by reducing the angular variation of the absolute value of magnetic flux by optimizing the size, shape, position, quantity of the rotor magnets 152, while taking the materials properties of the hard and soft magnet materials of the rotor magnets into consideration. It is also preferable that the circumferential spacing between rotor magnets 152 within a given layer of rotor assembly 150, and between adjacent layers and between separate rotor assemblies 150, is kept to an optimum value. In one embodiment, an optimum circumferential spacing between rotor magnets 152 is found such that the total area of each rotor magnet 152 equals 175%+/−20% of the area of a stator core end 202.

The spacing between the legs of the stator cores affects a number of factors. A large spacing reduces unwanted pole-to-pole flux leakage, but adds cost, since the axial length of the motor increases. Thus, more soft magnetic material is required, and core loss increases proportionately with the increased volume of core material. The optimal choice of leg spacing involves these considerations, as well as the effects of airgap, magnet pole surface area, and stator core surface area.

Staggering the rotor assemblies 150 circumferentially also produces lower loss characteristics. The magnetic flux variations of the rotor magnets 152 due to changes in position could also lead to unwanted losses in the magnet itself, due to both eddy currents and hysteresis. They result from a change in the magnetic permeability of the overall magnetic circuit, as experienced by each magnet. A change in magnetic permeability of the magnetic circuit results in a change in the magnetic flux produced by the magnets. This change in magnetic flux produces frequency dependent eddy current and hysteresis losses in the magnets. The losses do not occur at the commutating frequency (CF), which is the rotating speed multiplied by the number rotor pole pairs, where the rotor pole pairs is the number of rotor poles divided by two, and the rotating speed is in units of the number of revolutions per second (CF=rpm/60×pole/2). Rather the losses occur at a frequency that is equal to the revolutions per second multiplied by the number of stator teeth, where the number of stator teeth refers to the teeth that a DC magnet will encounter for each revolution. Thus, for a specific embodiment of a machine with the number of stator slot per phase per pole (SPP) value of 0.5, which is described in greater detail below, the number of stator teeth is equal to the number of rotor pole pairs times three.

Rotor magnets 152 can be any type of permanent magnet. Rare earth-transition metal alloy magnets such as samarium-cobalt magnets, other cobalt-rare earth magnets, or rare earth-transition metal-metalloid magnets, e.g., NdFeB magnets, are suitable. The rotor magnet structure may also comprise any other sintered, plastic-bonded, or ceramic permanent magnet material. Preferably, the magnets have high-energy product, coercivity, and saturation magnetization, along with a linear second-quadrant normal magnetization curve. More preferably, oriented and sintered rare earth-transition metal alloy magnets are used, since their higher energy product increases flux and hence torque, while allowing the volume of expensive permanent magnet material to be minimized. In alternate embodiments, rotor magnets 152 are constructed as electromagnets.

Rotor assembly 150, including rotor magnets 152, is supported for rotation on bearings 160 about the axis of a shaft 158 or any other suitable arrangement by rotor carrier 154, such that the poles of the magnets are accessible along a predetermined path adjacent the stator arrangement (see FIG. 4). FIG. 1 illustrates rectangular rotor magnets 152, wherein an outer length a₁, and an inner length a₂ are approximately equal. The rotor magnets 152 are preferably rectangular, as they are generally less expensive to produce. Trapezoidal, wedge-shaped magnets, such as those depicted in FIG. 17, may also be used. Rotor magnets with arcs presented to the airgap are an optimal design. In the illustration of FIG. 1, rotor magnets 152 with a curved shape would be defined by an outer arc length a₁ and an inner arc length a₂. Arc-shaped rotor magnets, however, are more expensive to produce. Additionally, for the high frequency embodiments of the invention having high pole counts, a large number of small rectangular rotor magnets are ordinarily used. Each outer length a₁ forms a chord subtending a rather small angle, which closely approximates an arc. Alternatively, rotor magnets 152 can be any polygonal shape. In still other embodiments, e.g. for switched reluctance designs, the motor may be constructed of a solid or laminated magnetic material, such as steel.

In a specific embodiment, the outer length a₁ of rotor magnet 152 and the width w of stator core 102 combined with stator coils 106 are substantially identical. If a₁ is much greater than w, magnetic flux lines does not cross the gap, rather they “leak” in some other direction. This is a detriment since magnets are expensive, and no benefit is obtained. Making a₁ significantly smaller than w results in lower magnetic flux density in the stator than could be obtained otherwise, which lowers the overall machine power density.

In still other embodiments, rotor magnet 152 may comprise one or more continuous solids, such as bonded magnets, with magnetic poles applied. In such embodiments, the number of rotor magnet pieces may differ from the effective working magnet pole count. It is recognized that the designer works with magnet pole count to determine motor operation and performance.

Any appropriate material able to properly support stator cores 102 or rotor magnets 152 may be used for stator carrier 104 and rotor carrier 154. Preferably, non-magnetic materials are used. However, stator carrier 104 and rotor carrier 154 can comprise a conducting material, with no restriction on the conductivity of the carrier material. Preferentially the carriers 104, 154 can be any high thermally conductive arrangement, with sufficient strength to support the rotor assembly 150 and the stator assembly 100 in relative position while permitting rotor assembly 150 to rotate. Other factors can also influence the choice of carrier material, such as a requirement of mechanical strength. In a specific embodiment, the stator carrier 104 or rotor carrier 154 is formed from aluminum. In another specific embodiment, the carrier material 104, 154 may be entirely organic, e.g., an organic dielectric such as a two part epoxy resin/hardener system. The active components of the electric device, e.g., stator core 102 and rotor magnets 152, may be fixed within stator carrier 104 and rotor carrier 154, respectively via adhesive, clamping, welding, fixturing, or other suitable attachment. Rotor carrier 154 is preferably mounted onto suitable bearing surfaces for ease of rotation about the axial shaft of the machine. A variety of bearings, bushings, and related items conventionally used in the motor industry are suitable.

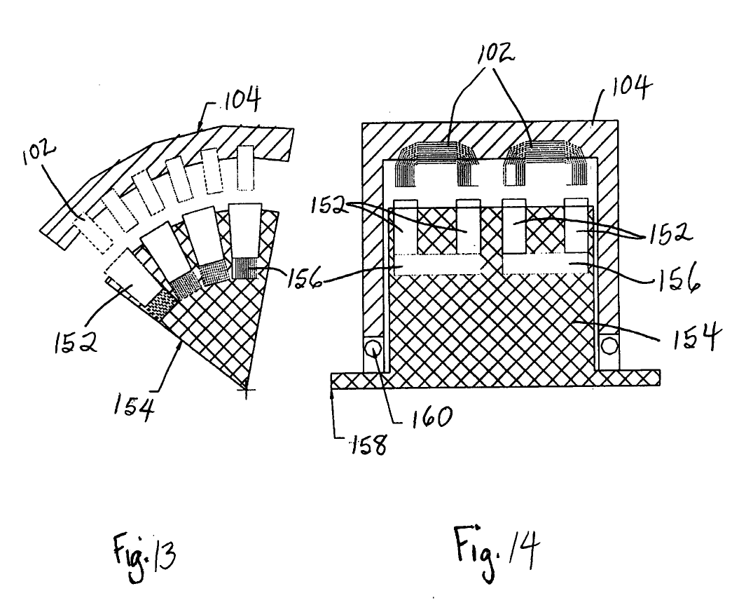

Multiple stator cores 102 can be wired into a common magnetic section. This corresponds to a slot per phase per pole (SPP) value of greater than 0.5, where the SPP ratio is determined by dividing the number of stator cores 102 by the number of phases in the stator winding and the number of DC poles (SPP=slots/phases/poles). According to the motor designs of the present invention, a slot refers to the spacing between alternating stator cores 102 within a plane orthogonal to the axis of rotation. In the calculation of the SPP value, a pole refers to the DC magnetic field that interacts with a changing magnetic field. Therefore, in the preferred embodiment, the permanent magnets mounted on (or set into) rotor carrier 154 provide the DC magnetic field, and hence the number of DC poles. In other embodiments of synchronous motors in accordance with the invention, a DC electromagnet provides the DC field. The electromagnets of the stator windings provide the changing magnetic field, i.e., one that varies with both time and position. The radial airgap electric device of the present invention may take on a wide variation of barrel or radial-type configurations. For example, the stationary stator assembly 100 may be centrally located, radially inward of concentrically located and spaced apart rotor assembly 150. The rotating portion with rotor magnets 152 could then be the outer portion of the electric device, and the stator assembly 100 may be the inner non-rotating portion. FIGS. 11 and 12 illustrate an embodiment of the invention wherein the rotor assembly 150 enclosed by the dashed line is the outside portion of the motor. It is this outer rotor assembly 150 that is capable of rotating, e.g., on suitable bearings (bearing are not shown). Any rotor carrier 154 similar to the other embodiments is suitable for use in the design of FIGS. 11 and 12. The stationary stator assembly 100, comprising stator coils 106 and stator cores 102, is on the inner non-rotating portion of the motor.

There may be also multiple alternating rotor assemblies 150 or multiple stator assemblies 100. FIGS. 13 and 14 illustrate one such embodiment having two rotor assemblies 150 and two stator assemblies 100. The axially arranged stator cores 102 are illustrated as mounted on a single unitary stator carrier 104. Similarly, the axially arranged rotor magnets 152 are set into a single contiguous rotor carrier 154. Alternatively, multiple separate rotor carriers joined on a shaft and/or separate stator carriers may also be used. Various winding schemes can be used in the embodiment of FIGS. 13-14, including a scheme wherein multiple stator cores 102, optionally comprised in different stator assemblies, share a common stator coil 106.

In a further aspect of the invention, there is provided a radial airgap, transverse flux rotating machine operably connected to suitably designed power electronics. For example, the power electronics are preferably designed to minimize power electronics (PE) ripple, which is an undesirable variation in torque during operation of a motor and can adversely affects performance. Commutating at high frequencies with such motors having low inductance and maintaining low speed control are preferably optimized together.

As used herein, the term “power electronics” is understood to mean electronic circuitry adapted to convert electric power supplied as direct current (DC) or as alternating current (AC) of a particular frequency and waveform to electric power output as DC or AC, the output and input differing in at least one of voltage, frequency, and waveform. The conversion is accomplished by a power electronics conversion circuitry. For other than a simple voltage transformation of AC power using an ordinary transformer that preserves frequency and simple bridge rectification of AC to provide DC, modern power conversion ordinarily employs non-linear semiconductor devices and other associated components that provide active control.

Motoring machines must be supplied with AC power, either directly or by commutation of DC power. Although mechanical commutation with brush-type machines has long been used, the availability of high-power semiconductor devices has enabled the design of brushless, electronic commutation means, that are used with many modern permanent magnet motors. In generating mode, a machine (unless mechanically commutated) inherently produces AC. A large proportion of machines are said to operate synchronously, by which is meant that the AC input or output power has a frequency commensurate with the rotational frequency and the number of poles. Synchronous motors directly connected to a power grid, e.g. the 50 or 60 Hz grid commonly used by electric utilities or the 400 Hz grid often used in shipboard and aerospace systems, therefore operate at particular speeds, with variations obtainable only by changing pole count. For synchronous generation, the rotational frequency of the prime mover must be controlled to provide a stable frequency. In some cases, the prime mover inherently produces a rotational frequency that is too high or low to be accommodated by motors that have pole counts within practical limits for known machine designs. In such cases, the rotating machine cannot be connected directly to a mechanical shaft, so a gearbox often must be employed, despite the attendant added complexity and loss in efficiency. For example, wind turbines rotate so slowly that an excessively large pole count would be required in a conventional motor. On the other hand, to obtain proper operation with desired mechanical efficiency, typical gas turbine engines rotate so rapidly that even with a low pole count, the generated frequency is unacceptably high. The alternative for both motoring and generating applications is active power conversion.

As discussed hereinabove in greater detail, machines constructed in accordance with the present invention are operable as motors or generators over a much wider range of rotational speed than conventional devices. In many cases, the gearboxes heretofore required in both motor and generator applications can be eliminated. However, the resulting benefits also require the use of power electronics operable over a wider electronic frequency range than employed with conventional machines.

In another aspect of the present invention there is provided a dynamoelectric machine system including a dynamoelectric machine of any of the aforementioned types operably connected to power electronics means for interfacing and controlling the machine. For motoring applications, the machine is interfaced to an electrical source, such as the electrical power grid, electrochemical batteries, fuel cells, solar cells, or any other suitable source of electrical energy. A mechanical load of any requisite type may be connected to the machine shaft. In generating mode, the machine shaft is mechanically connected to a prime mover, which may be any source of rotational mechanical energy and the system is connected to an electrical load, which may include any form of electrical appliance or electrical energy storage. The machine system may also be employed as regenerative motor system, for example as a system connected to the drive wheels of a vehicle, alternately providing mechanical propulsion to the vehicle and converting the vehicle's kinetic energy back to electrical energy stored in a battery to effect braking.

One exemplary embodiment of a dynamoelectric machine system includes a dynamoelectric machine having at least one stator assembly, a plurality of stator windings, and at least one rotor assembly supported for rotation about a rotational axis, said rotor and stator assemblies being concentric with said rotational axis. The rotor assembly comprises at least two rotor layers having equal numbers of discrete rotor magnets, each of said magnets having a polarity defining north and south poles at opposite ends thereof, said layers being substantially planar, perpendicular to said rotational axis, and axially spaced apart, said magnets in each layer being disposed equiangularly about the circumference of said rotor assembly, such that: (i) one of said ends of each of said magnets is on a cylindrical periphery of said rotor assembly; (ii) said ends on said periphery have circumferentially alternating north and south poles; and (iii) each of said magnets is magnetically linked to an adjacent one of said magnets by a magnetically permeable linking member situated proximate the other of said ends of said adjacent magnet. The stator assembly comprises a plurality of stator cores, each of said stator cores terminating in a first and a second stator poleface, said stator cores being disposed equiangularly about the circumference of said stator assembly, such that: (i) said first and second stator polefaces of each of said stator cores are situated on a cylindrical periphery of said stator assembly in axial alignment; (ii) said first stator polefaces are in a first stator layer radially adjacent one of said rotor layers; and (iii) said second stator polefaces are in a second stator layer adjacent another of said rotor layers. Stator windings encircle the stator cores.

The dynamoelectric machine system further comprises power electronics means. Power electronics means useful in the present system ordinarily must include active control with sufficient dynamic range to accommodate expected variations in mechanical and electrical loading, while maintaining satisfactory electromechanical operation, regulation, and control. Any form of power conversion topology may be used, including switching regulators employing boost, buck, and flyback converters and pulsewidth modulation. Preferably both voltage and current are independently phase-controllable, and control of the power electronics may operate either with or without direct shaft position sensing. In addition, it is preferred that four-quadrant control be provided, allowing the machine to operate for either clockwise or counterclockwise rotation and in either motoring or generating mode. Both current-loop and velocity-loop control circuitry is preferably included, whereby both torque-mode and speed-mode control are can be employed. For stable operation, power electronics means must preferably have a control-loop frequency range at least about 10 times as large as the intended commutating frequency. For the present system, operation of the rotating machine at up to about 2 kHz commutating frequency thus requires a control-loop frequency range of at least about 20 kHz.

Through the present invention, radial airgap electric machines incorporating advanced material are now possible. There are a number of applications that demand radial gap motors, including, but not limited to, some gasoline and diesel engines that have an integrated starter/alternator. In these applications, manufacturing assembly dictates the ability to assemble the stator as a separate component from the rotor. This is very difficult using axial airgap motors, but comparatively much easier using radial airgap motors. These applications can now benefit from the high frequency design characteristics of the amorphous, nanocrystalline or flux-enhancing Fe-based metal. As these materials are readily available, the invention does not rely on any change to the existing material supply chains. Any improvement to the amorphous, nanocrystalline or flux-enhancing Fe-based metal, permanent magnets, or copper wires will readily apply to this invention. The rectangular rotor magnets 152 of the preferred embodiments are simple to manufacture, and the stator coils 106 may be readily manufactured bobbin wound types.

The invention can also be readily miniaturized, even to the point of being mounted in its entirety on small printed circuit board type components.

There are several benefits of certain embodiments of the present transverse flux radial gap motor as compared to conventional radial airgap motor. Amorphous metal, nanocrystalline metal ribbon or grain-oriented or non-grain-oriented Fe-based materials can be incorporated in a radial airgap configuration in a cost effective manner, a design which has been sought by industry for many years.

Although permanent magnets of a number of shapes may be used in constructing the present motors, rectangular rotor permanent magnets are preferred in most embodiments, since they less expensive to manufacture, as magnet-pressing technology does not readily lend itself to direct formation of arcs and curved surfaces. Such features are frequently added after pressing the permanent magnet material (e.g., NdFeB, SmCo, or other rare-earth based magnetic powder) into a rectangular shape, using a costly grinding operation, with resultant material waste. As previously discussed, the embodiments of the invention with high pole count lend themselves to very optimized rotor magnet designs using rectangular shaped magnets. The high pole count motors provide for high frequency radial airgap motors.

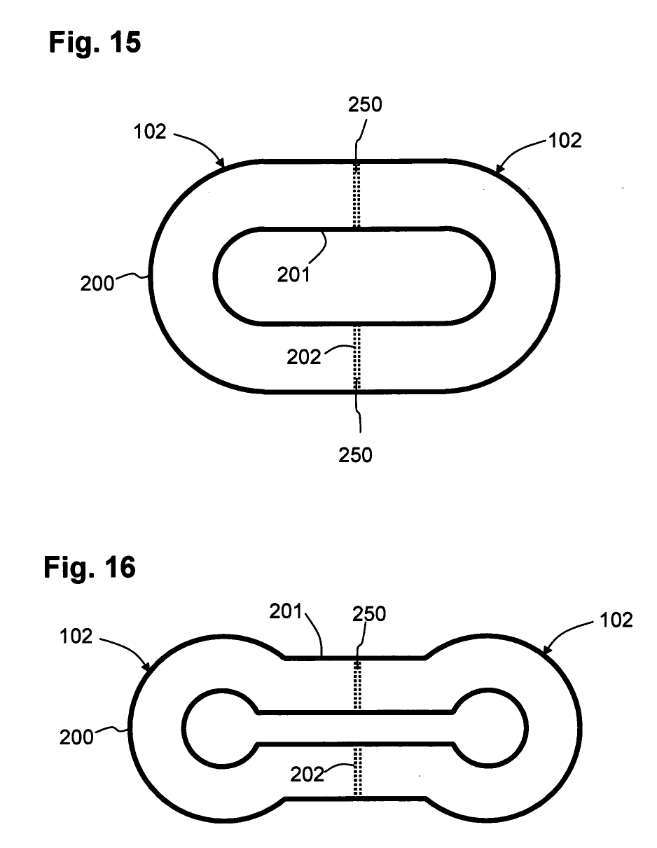

The stator cores can also be manufactured in a way that requires very little machining. For example, ribbon can be wound helically into a racetrack-like shape, as depicted by FIG. 15. The shape can then be cut along lines 250 to form two identical horseshoe shapes 102. The layers of metal can thus be cut in a single collective step, instead of layer by layer, as required in conventional lamination stamping processes. Advantageously, the stator cores can be produced by such a winding process with virtually no waste of the soft magnetic materials. Other suitable stator core forms can be prepared by similar processes, such as the form depicted by FIG. 16, which provides a stator core with an enlarged base portion 200. The linking members 156 may also be manufactured in a similar fashion. The same materials appointed for use in the stator cores are also preferred for manufacturing the linking members. Many of these manufacturing methods are currently practiced in volume for producing components appointed for other non-motor devices.

There are even cost saving advantages of the transverse flux radial gap motor of the invention over axial airgap motors. For example, the axial forces acting on the bearing systems in axial airgap machines are considerably larger than in the present transverse flux radial gap motor, so that lower cost bearing systems can be used in the present device.

The invention also provides a natural and straightforward method of reducing first-order cogging, due to the dual layers of rotor magnets in the axial direction. A characteristic of first-order torque cogging is that it has a natural fundamental frequency that is six times the commutating frequency of the machine. A method of reducing the first-order cogging is to construct the axial pair of north-south rotor magnets such that they are no longer positioned as being axially aligned on a line parallel to the axis, i.e., they are skewed relative to each other by an angle Φ as shown in FIG. 17. Preferably, Φ is chosen such that the magnets are skewed by an amount ranging up to about one half the distance between circumferentially adjacent stator cores. This modification would require that all of the coils on each stator core be electrically wired in series. The skewing of the rotor magnet position by the ½ stator core circumferential distance causes the generated electromagnetic force (EMF) to fall by approximately 3.5%. Power is reduced accordingly. However, such reductions are acceptable in view of the marked reduction in cogging that can be obtained concomitantly.

Polyphase Transverse Flux Radial Airgap Motor

The present transverse flux, radial airgap motor is highly suited to be constructed and operated in a polyphase arrangement. For example, the rotor assemblies 150 can be subdivided into several sections, as illustrated by the dashed lines in FIG. 1. Each section comprises four rotor magnets 152 arranged such that there are two north-south rotor magnet pairs in an axial direction, and two north-south pairs in the circumferential direction.

The stator assembly section that is opposite the rotor assembly section matches comprises three stator cores 102, each representing one phase of a three-phase motor. When the coils 106 encircling stator core ends 202 are energized, the opposite stator core ends 202 of each stator core 102 will have opposite magnetic polarity to form north-south magnetic poles pairs.

Although the present motor may be designed and operated as a single-phase device or a polyphase device with any number of phases, a three-phase motor is preferred in accordance with industry convention. For the three-phase motor, with a slot/pole/phase ratio=0.5, the number of rotor poles is two-thirds the number of stator slots, with the number of slots being a multiple of the number of phases. While the machine is usually wired in three-phase wye configuration in accordance with industry convention, a delta-configuration may also be employed.

For example, the embodiment of the present machine depicted by FIG. 1 is operable as a three-phase motor by energizing the coils with a three-phase power supply. The machine can most readily be analyzed when the section enclosed in the dashed line of FIG. 1 is further subdivided on a plane orthogonal to the axis of rotation into two sub-portions, bisecting each stator core 102, as represented by the dashed line of FIG. 2. This also separates the axial north-south rotor magnet pairs. This sub-portion is different from a conventional radial gap motor in two respects. Firstly, the three stator phases are not physically connected by a common backiron piece, as would be the case in a conventional radial air gap motor, where the common backiron piece provides magnetic coupling. Secondly, the two rotor magnets are not connected by a common rotor piece, which also provides magnetic coupling.

The transverse flux radial gap motor is optionally built in small sections and subsequently assembled, which is a desirable approach in building very large machines (e.g., greater than two meters in diameter). The coils can be readily made using low-cost bobbin winding techniques, which can decrease manufacturing costs. The magnetic forces encountered during assembly, even with premagnetized rotor magnets, can safely be accommodated by segmented assembly.

High Pole Count, High Frequency Designs Using a Low-Loss Material

In a specific embodiment, the present invention also provides a radial airgap electric device with a high pole count that operates at high frequencies, i.e., a commutating frequency greater than about 400 Hz. In some cases, the device is operable at a commutating frequency ranging from about 500 Hz to 2 kHz or more. Designers ordinarily have avoided high pole counts for high speed motors, since conventional stator core materials, such as Si—Fe, cannot operate at the proportionately higher frequencies necessitated by the high pole count. In particular, known devices using Si—Fe cannot be switched at magnetic frequencies significantly above 400 Hz due to core losses resulting from changing magnetic flux within the material. Above that limit, core losses cause the material to heat to the point that the device cannot be cooled by any acceptable means, Under certain conditions, the heating of the Si—Fe material may even be severe enough that the machine cannot be cooled whatsoever, and will self-destruct. However, it has been determined that the low-loss characteristics of amorphous, nanocrystalline and non-grain-oriented metals allow much higher switching rates than Si—Fe materials. While, in a preferred embodiment, the choice of METGLAS® alloy removed the system limitation due to heating at high frequency operation, the rotor design and overall motor configuration have also been improved to better exploit the properties of the amorphous material.

The ability to use much higher exciting frequencies permits the present machines to be designed with a much wider range of possible pole counts. The number of poles in the present devices is a variable based on the permissible machine size (a physical constraint) and on the expected performance range. Subject to allowable excitation frequency limits, the number of poles can be increased until magnetic flux leakage increases to an undesirable value, or performance begins to decrease. There is also a mechanical limit presented by stator construction on the number of rotor poles, since stator slots must coincide with the rotor magnets. In addition, there is a mechanical and electromagnetic limit in concert on the number of slots that can be made in the stator, which in turn is a function of the frame size of the machine. Some boundaries can be set to determine the upper limits of slots for a given stator frame with proper balance of copper and soft magnetic material, which can be used as a parameter in making good performing radial gap machines. The present invention provides motors with about 4 or 5 times greater numbers of poles than industry values for most machines.

As an example, for an industry typical motor having 6 to 8 poles, for motors at speeds of about 800 to 3600 rpm, the commutating frequency is about 100 to 400 Hz. The commutating frequency (CF) is the rotating speed multiplied by the number of pole pairs, where the pole pairs is the number of poles divided by two, and the rotating speed is in units of revolutions per second (CF=rpm/60×pole/2). Also available in industry are devices with greater than 16 poles, but speeds of less than 1000 rpm, which still correspond to a frequency less than 400 Hz. Alternatively, motors are also available with a relatively low pole count (e.g. less than 6 poles), and with speeds up to 30000 rpm, which still have a commutating frequency less than about 400 Hz. In representative embodiments, the present invention provides machines that are 96 poles, 1250 rpm, at 1000 Hz; 54 poles, 3600 rpm, at 1080 Hz; 4 poles, 30000 rpm, at 1000 Hz; and 2 poles, 60000 rpm, at 1000 Hz. The high frequency motors of the invention can operate at frequencies of about 4 to 5 times higher than known radial airgap motors made with conventional materials and designs. The present motors are more efficient than typical radial airgap motors in the industry when operated in the same speed range, and as a result provide greater speed options. The present configuration is particularly attractive for the construction of very large motors. Using a combination of a high pole count (e.g. at least 32 poles) and a high commutation frequency (e.g. a frequency of 500 to 2000 Hz), very large machines can be constructed in accordance with the invention in a manner that combines high energy efficiency, high power density, ease of assembly, and efficient use of expensive soft and hard magnetic materials.

Ideally, both rotor magnets 152 and stator core ends 202 should have arced faces that are presented to the air gap. However, the high pole counts possible in the present machine allows the surfaces of magnets 152 and stator core ends presented to the air gap to be flat. In high pole count devices, the facing surfaces subtend only a small angle, so a flat surface is a sufficiently close approximation of a face which is an arc segment of a cylindrical surface. As a result of the combined high pole count and high frequency made possible by use of amorphous, nanocrystalline or flux-enhancing Fe-based magnetic material in the stator, cheaper, rectangular shaped rotor magnets 152 can thus be used. In addition, the stator cores can also be fabricated with planar faces for the same reasons, leading to additional cost savings. Stator cores and rotor magnets of these shapes still make very efficient use of available space without incurring a performance penalty.

Slots Per Phase Per Pole Ratio

The design of the present machine affords considerable flexibility in the selection of an optimal SPP ratio. In a preferred embodiment, the invention provides a motor wherein the SPP ratio is optimally equal to 0.5.

Conventionally designed machines frequently provide an SPP ratio of 1 to 3 to obtain acceptable functionality and noise levels and provide smoother output due to better winding distribution. However, designs with a lower SPP value, e.g. 0.5, have been sought to reduce the effect of end turns. End turns are the portions of wire in the stator that connect the windings between slots. Although such connection is, of course, required, the end turns do not contribute to the torque and power output of the machine. In this sense they are undesirable, in that they increase the amount of wire required and contribute ohmic losses to the machine while providing no benefit. Hence, one goal of the motor designer is to minimize end turns and provide a motor with manageable noise and cogging. On the other hand, preferred implementations of the present motor allow reduced SPP ratio, along with desirably low noise and cogging. Such a benefit is obtained by operating with a high pole and slot count. These options were not viable in previous machines, because the required increase in commutating frequency is unacceptable without the use of advanced, low loss stator materials.

Preferred embodiments of the present machine are beneficially designed with an SPP ratio of 1 or less, more preferably 0.5 or less. It is possible to wire multiple slots into a common magnetic section, thereby providing an SPP greater than 0.5. This is the result of there being a greater number of stator slots than rotor poles, resulting in a distributed winding. A value of SPP less than or equal to 0.5 indicates that there are no distributed windings. A convention in the industry is to include distributed windings in the stator. However, distributed windings will raise the value of SPP, and reduce the frequency for a given speed. As a result, in conventional machines that have SPP=0.5, and operate at low frequency, there will also be a low pole count. A low pole count combined with an SPP=0.5 results in high, difficult to control cogging.

For some applications, it is advantageous to build a motor with a fractional value of SPP, since such a motor may employ pre-formed coils around a single stator tooth. In different embodiments of the present machine, the SPP ratio is an integral ratio, such as 0.25, 0.33, 0.5, 0.75, or 1.0 SPP may also be greater than 1.0. In a preferred embodiment particularly suited for three-phase use, the SPP ratio is 0.5.

Flexibility in Wiring/Winding Design

A further advantage of the certain embodiments of the present stator structure is that is that alternative wiring conditions may be used with the same structure. Traditional stator designs limit winding design choices because of the above-mentioned focus on using SPP ratios of 1.0 to 3.0, which require distributing the windings over multiple stator cores 102. It becomes difficult to have more than two or three winding options with distributed windings. The present configuration provides the ability to take advantage of the SPP=0.5 design, wherein there is typically only one discrete coil per stator tooth. However, the invention does not exclude other arrangements with SPP=0.5. Embodiments with single tooth coils can be easily modified and reconnected to provide any voltage demanded by a given application. Thus a single set of motor hardware in accordance with the present invention can provide a broad range of solutions simply by changing the coil. Generally, the coil is the easiest component in an electromagnet circuit to modify.

Thus, given an SPP ratio approaching 0.5 as in the device of this invention, there is significant flexibility as to stator winding configurations. For example, the manufacturer may wind each stator separately from one another, or the manufacturer may provide separate stator windings within the same stator. This capability is one of the advantages of a system with a SPP equal to 0.5. Although there have occasionally been industry systems for certain specialized applications that employ SPP=0.5, they are not widespread and have met with limited success for general usage. The present invention successfully provides a system with SPP equal to 0.5 that allows for this flexibility in winding.

Thermal Properties

One of the characteristics that limits device output and speed in all electric devices, including both those using Si—Fe alloys and those using amorphous, nanocrystalline or grain-oriented or non-grain-oriented Fe-based metals, is waste heat. This waste heat comes from a number of sources, predominantly ohmic losses, skin and proximity effect losses, rotor losses from eddy currents in magnets and other rotor components, and core loss from the stator core. Because of the large amounts of waste heat generated, conventional machines soon reach the limit of their ability to discard the waste heat. The “continuous power limit” of conventional machines is often determined by the maximum speed at which the machine can operate continuously while still dissipating all of the waste heat that is generated. The continuous power limit is a function of the current. The power limit is further affected by the allowable temperature rise, which must be chosen consistent with the temperature ratings of insulation and other components in the motor. In motors designed to operate in air, the choice of an open or closed frame determines in part the extent of cooling flow. Some applications permit liquid cooling, which improves heat extraction ability and provides a higher rating and higher power density, but at the expense of a more complicated device. Various implementations of the present machine can employ any or all of these variants.

In the device of the present invention, however, less waste heat is generated because amorphous, nanocrystalline or grain-oriented or non-grain-oriented Fe-based materials have lower losses than Si—Fe, and the designer can exploit these low-loss characteristics by increasing frequency, speed and power, and then correctly balancing and “trading” the low core loss vs. ohmic loss. Many of the improved soft materials used in embodiments of the present device also have lower exciting current, further reducing ohmic losses. Overall, for the same power as conventional machines, the motor of the present invention exhibits lower loss, and hence higher torques and speeds. Accordingly, devices of the present invention can frequently achieve higher continuous speed limits than conventional machines.

Improved Efficiency

Embodiments of the present invention in most cases provide a device which achieves required performance, yet is both efficient and cost effective. The efficiency is defined as the power output of the device divided by the power input. The ability of machines of the present invention to operate simultaneously at higher commutating frequencies with the high pole count results in more efficient devices having both low core losses and high power density. For the high frequency designs, the frequency limit of 400 Hz has been an industry standard beyond which few, if any applications have heretofore been practical.

The performance and increased efficiency of the present invention is not simply an inherent feature of replacing Si—Fe with amorphous metal. Several entities have tried and failed to successfully design a viable radial airgap motor using these materials. The present invention provides a novel stator design that exploits the amorphous, nanocrystalline or grain-oriented or non-grain-oriented Fe-based materials' properties to provide a radial airgap motor.

The present invention also provides devices in which efficiency losses, including hysteresis losses, are significantly reduced. Hysteresis losses result from impeded domain wall motion during magnetization for the grain-oriented Si—Fe alloys, which can contribute to the overheating of the core. As a result of the increased efficiency, the motor of the present invention is capable of achieving a greater continuous speed range. The speed range issue is described as torque-speed. Conventional motors are limited in that they can either provide low torque for high-speed ranges (low power), or high torque for low-speed ranges. The present invention successfully provides motors with high torque for high-speed ranges.

Having thus described the invention in rather full detail, it will be understood that such detail need not be strictly adhered to, but that additional changes and modifications, along with additional arrangements and instrumentalities, may suggest themselves to one skilled in the art, all falling within the scope of the invention as defined by the subjoined claims.

What is claimed is:

1. A dynamoelectric machine, comprising:
(a) at least one stator assembly, a plurality of stator windings, and at least one rotor assembly supported for rotation about a rotational axis, said rotor and stator assemblies being concentric with said rotational axis;
(b) said at least one rotor assembly comprising at least one rotor magnet structure, said magnet structure providing magnetic poles having north and south polarity, said poles being disposed in at least two rotor layers that are substantially planar, perpendicular to said rotational axis, and axially spaced apart, each of said layers having the same number of poles, and said poles in each of said layers being disposed equiangularly about the circumference of said rotor assembly on a cylindrical periphery thereof;
(c) said at least one stator assembly comprising a plurality of stator cores, each of said stator cores terminating in a first and a second stator poleface, said stator cores being disposed equiangularly about the circumference of said stator assembly, such that:
(i) said first and second stator polefaces of each of said stator cores are situated on a cylindrical periphery of said stator assembly in axial alignment;
(ii) said first stator polefaces are in a first stator layer radially adjacent one of said rotor layers; and
(iii) said second stator polefaces are in a second stator layer adjacent another of said rotor layers; and
(d) said stator windings encircling said stator cores.

2. A dynamoelectric machine as recited by claim 1, wherein said magnets are composed of a rare earth-transition metal alloy.

3. A dynamoelectric machine as recited by claim 2, wherein said magnets are SmCo or FeNdB magnets.

4. A dynamoelectric machine as recited by claim 1, wherein poles of opposite polarity in said rotor layers are in axial alignment.

5. A dynamoelectric machine as recited by claim 1, wherein poles of opposite polarity in said rotor layers are skewed by an amount ranging up to about one half the distance between said circumferentially adjacent stator cores.

6. A dynamoelectric machine as recited by claim 1, comprising a plurality of said magnet structures providing said magnetic poles.

7. A dynamoelectric machine as recited by claim 1, wherein said stator cores comprise laminated layers composed of a material selected from the group consisting of amorphous, nanocrystalline, and flux enhancing Fe-based metal.

8. A dynamoelectric machine as recited by claim 7, wherein said laminated layers are composed of amorphous metal.

9. A dynamoelectric machine as recited by claim 7, wherein said laminated layers are composed of nanocrystalline metal.

10. A dynamoelectric machine as recited by claim 7, wherein said laminated layers are composed of non-oriented Fe-based metal consisting essentially of an alloy of Fe and about 6.5 wt. % Si.

11. A dynamoelectric machine as recited by claim 1, having a slot per phase per pole ratio that ranges from about 0.25 to 4.0.

12. A dynamoelectric machine as recited by claim 11, having a slot per phase per pole ratio that ranges from about 0.25 to 1.

13. A dynamoelectric machine as recited by claim 12, having a slot per phase per pole ratio of 0.50.

14. A dynamoelectric machine as recited by claim 1, having at least 16 poles.

15. A dynamoelectric machine as recited by claim 1, adapted to run with a commutating frequency ranging from about 500 Hz to 2 kHz.

16. A dynamoelectric machine as recited by claim 15, having at least 32 poles.

17. A dynamoelectric machine as recited by claim 1, wherein said rotor assembly is radially inward of said stator assembly.

18. A dynamoelectric machine as recited by claim 1, wherein said stator assembly is radially inward of said rotor assembly.

19. A dynamoelectric machine system, comprising a dynamoelectric machine and power electronics means for interfacing and controlling said machine and being operably connected thereto, the dynamoelectric machine comprising:
(a) at least one stator assembly, a plurality of stator windings, and at least one rotor assembly supported for rotation about a rotational axis, said rotor and stator assemblies being concentric with said rotational axis;
(b) said at least one rotor assembly comprising at least two rotor layers having equal numbers of discrete rotor magnets, each of said magnets having a polarity defining north and south poles at opposite ends thereof, said layers being substantially planar, perpendicular to said rotational axis, and axially spaced apart, said magnets in each layer being disposed equiangularly about the circumference of said rotor assembly, such that:
(i) one of said ends of each of said magnets is on a cylindrical periphery of said rotor assembly;
(ii) said ends on said periphery have circumferentially alternating north and south poles; and
(iii) each of said magnets is magnetically linked to an adjacent one of said magnets by a magnetically permeable linking member situated proximate the other of said ends of said adjacent magnet;
(c) said at least one stator assembly comprising a plurality of stator cores, each of said stator cores terminating in a first and a second stator poleface, said stator cores being disposed equiangularly about the circumference of said stator assembly, such that:
(i) said first and second stator polefaces of each of said stator cores are situated on a cylindrical periphery of said stator assembly in axial alignment;
(ii) said first stator polefaces are in a first stator layer radially adjacent one of said rotor layers; and
(iii) said second stator polefaces are in a second stator layer adjacent another of said rotor layers; and
(d) said stator windings encircling said stator cores.

20. For use in a dynamoelectric machine having a rotational axis:
at least one rotor magnet structure providing magnetic poles having north and south polarity, said poles being disposed in at least two rotor layers that are substantially planar, perpendicular to said rotational axis, and axially spaced apart, each of said layers having the same number of poles, and said poles in each of said layers being disposed equiangularly about the circumference of said rotor assembly on a cylindrical periphery thereof.
